(19) United States
(12) Patent Application Publication
(10) Pub. No.: US 2012/0133293 A1
(43) Pub. Date: May 31, 2012

(54) STEPDOWN DC-DC CONVERTER FOR LIGHT EMITTING DIODE, AND POWER SUPPLY DEVICE AND METHOD USING THE SAME

(75) Inventor: Yun Tae SHIN, Namyangju-si (KR)

(73) Assignee: SETi Co., Ltd., Seongnam-si (KR)

(21) Appl. No.: 12/980,516

(22) Filed: Dec. 29, 2010

(30) Foreign Application Priority Data
Nov. 29, 2010 (KR) 10-2010-0119818

(51) Int. Cl. H05B 37/00

(52) U.S. Cl. 315/200 R

(57) ABSTRACT

A stepdown DC-DC converter is adapted to provide a power supply voltage necessary to control the operation of an LED. The stepdown DC-DC converter includes: a reference voltage supplier for providing a reference voltage; a feedback unit for feeding back the power supply voltage on an output line; an operational amplifier for operationally amplifying the reference voltage and the fed-back power supply voltage; a switch unit for switching on/off a DC voltage on an input line toward the output line; and a charging and discharging circuit for selectively performing a charging operation of the switched voltage from the switch unit and a discharging operation of its charged voltage according to the switching operation of the switch unit to provide the power supply voltage to the output line.

### FIELD OF THE INVENTION

The present invention relates to device and method of supplying a power supply voltage to an LED (Light emitting diode) controller which controls the operation of an LED lamp. More particularly, the present invention relates to a stepdown DC-DC (Direct Current to Direct Current) converter adapted to apply a power supply voltage to an LED controller using a stepdown DC-DC converting, and LED power supply device and method using the same.

### BACKGROUND OF THE INVENTION

Nowadays, an LED lamp is being manufactured in the shape of a semiconductor device unlike a fluorescent lamp, an incandescent electric lamp, a street lamp, a localized illumination, and so on. The LED lamp emits light when a constant electric current necessary therefor is applied by a forward bias voltage of about 3.3V. Such an LED lamp needs an LED power supply device for deriving a DC (Direct Current) power supply voltage, which is required by an LED controller, from an input AC (Alternative Current) power supply voltage.

FIG. 1 is a block diagram showing an LED illumination system employing a typical LED power supply device. The LED illumination system includes a transformer 102, a rectifier 104, a smooth circuit 106, a power factor compensation circuit 108, an LED controller 110, and an LED module 112. Among the components of the LED illumination system, the transformer 102, rectifier 104, smooth circuit 106 and power factor compensation (‘PFC’) circuit 108 may be defined to configure an LED power supply device.

The transformer 102 transforms an externally input AC voltage into the AC voltage of a desired level using primary and secondary windings. The rectifier 104 is configured with one or more diodes, and serves to convert (or rectify) the transformed AC voltage into a DC voltage.

Subsequently, the smooth circuit 106 may be configured to include, for example, a lossless low pass filter. Such a smooth circuit 106 eliminates ripple components included in the output voltage of the rectifier 104, thereby allowing the output voltage of the rectifier 104 to be converted into the DC voltage of a fixed level. The power factor compensation circuit 108 synchronizes the output voltage of the smooth circuit 106 with the total load current so as to compensate for a power factor. The power-factor-compensated DC voltage is used as a power supply voltage of the LED controller 110.

The LED controller 110 uses also the power-factor-compensated DC voltage as an input voltage. Such an LED controller 110 controls the operations of LED lamps included in the LED module 112.

In this manner, the LED power supply device employs the transformer for transforming the external input AC voltage into the AC voltage of a desired level. As such, there is a disadvantage of enlarging a substrate, to which a driving circuits including the LED controller are mounted, due to the physical structure and size of the transformer.

To consider the disadvantage in the LED illumination system, it is necessary to develop the LED power supply device without employing the transformer. However, it has been not suggested or proposed any technical solution without employing the transformer up to the present.

### SUMMARY OF THE INVENTION

In view of the above, the present invention provides a stepdown DC-DC converter which is adapted to apply a power supply voltage to an LED without employing a transformer, and LED power supply device and method using the same.

In accordance with a first aspect of the present invention, there is provided a stepdown DC-DC converter for applies a power supply voltage necessary to control an LED, includes:

a reference voltage supplier for providing a reference voltage;

a feedback unit for feeding back the power supply voltage on an output line of the stepdown DC-DC converter;

an operational amplifier for performing an operational amplification on the reference voltage and the fed-back power supply voltage;

a switch unit for switching on/off a DC voltage on an input line of the stepdown DC-DC converter toward the output line; and

a charging and discharging circuit for selectively performing a charging operation of the switched voltage from the switch unit and a discharging operation of its charged voltage according to the switching operation of the switch unit to provide the power supply voltage to the output line.

In accordance with a second aspect of the present invention, there is provided an LED power supply device for supplying a power supply voltage to an LED controller controlling the operation of an LED lamp, includes:

a rectifier for rectifying an input AC voltage into a DC voltage;

a smooth unit for eliminating a ripple voltage included in the rectified DC voltage to produce a smoothed voltage;

a power factor compensator for performing power factor compensation by phase-synchronizing the smoothed voltage with a total load electric-current; and

a stepdown DC-DC converter for stepping down the power-factor-compensated DC voltage into the power supply voltage required by the LED controller.

In accordance with a third aspect of the present invention, there is provided a method of supplying a power supply voltage to an LED controller controlling the operation of an LED lamp, comprising:

rectifying an input AC voltage into a DC voltage before eliminating a ripple voltage included in the rectified DC voltage to produce a smoothed voltage;

performing power factor compensation for the smoothed voltage in synchronization with the phase of a total load electric-current to produce a power-factor-compensated DC voltage; and

stepping-down the power-factor-compensated DC voltage into the power supply voltage required by the LED controller and applying the stepped-down voltage to the LED controller.

### BRIEF DESCRIPTION OF THE DRAWINGS

The above and other objects and features of the present invention will become apparent from the following description of embodiments given in conjunction with the accompanying drawings, in which:

FIG. 1 is a block diagram showing an LED illumination system with an ordinary LED power supply device;

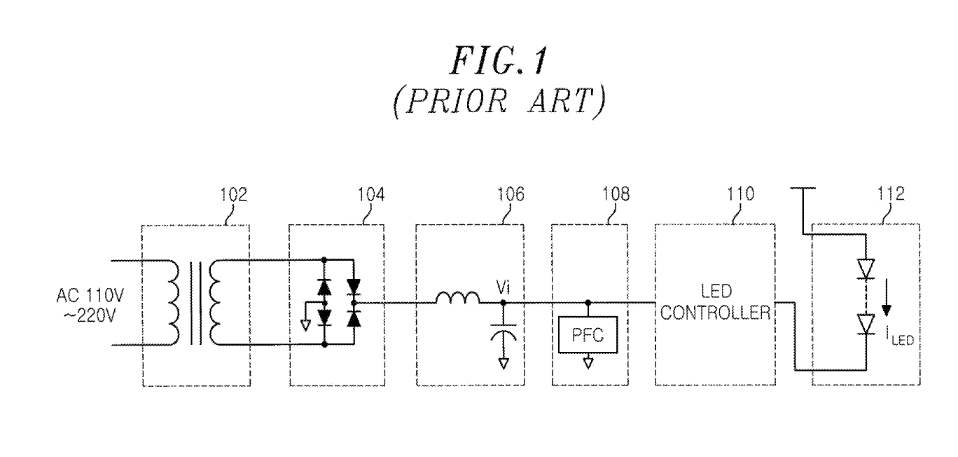

FIG. 2 is a configuration diagram showing an LED illumination system with an LED power supply device in accordance with an embodiment of the present invention;

FIG. 3 is a circuitry diagram showing a step-down DC-DC converter for an LED in accordance with the present invention;

FIG. 4 is a circuitry diagram showing a LED controller adopted in the present invention;

FIG. 5 is a waveform diagram illustrating an AC-DC converting process which is performed according to the present invention; and

FIG. 6 is a graphic diagram illustrating changing/discharging operations of inductor and capacitor which are included in a charging and discharging circuit.

### DETAILED DESCRIPTION OF THE EMBODIMENTS

Hereinafter, preferable embodiments of the present invention will be described in detail with reference to the accompanying drawings so that they can be readily implemented by those skilled in the art.

Also, in the following description of the present invention, the detailed description of the related art, which is known to those skilled in the art, will be omitted in case that there is possibility that it makes the subject matter of the present invention to be indistinct without necessity.

Moreover, terms in the following description will be defined based on functional sides in the present invention. As such, the defined terms can be changed according to a user, the purposes of an operator, a usual practice, or others. Therefore, the defined terms should be read on the basis of a subject matter which is specified through the present disclosure.

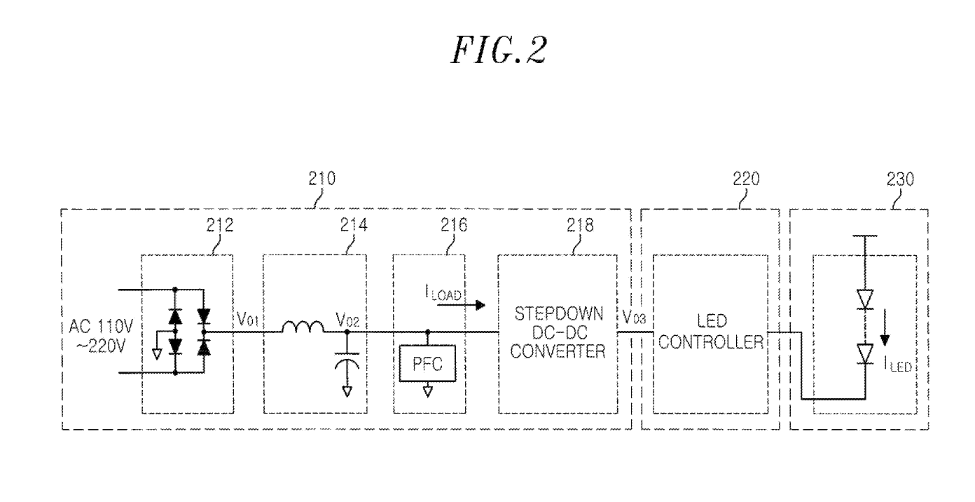

FIG. 2 is a configuration diagram showing an LED illumination system with an LED power supply device in accordance with an embodiment of the present invention. The LED illumination system includes an LED power supply device 210, an LED controller 220, and an LED module 230. The LED power supply device 210 includes a rectifier 212, smooth unit 214, a power factor compensator 216, and a stepdown DC-DC converter 218.

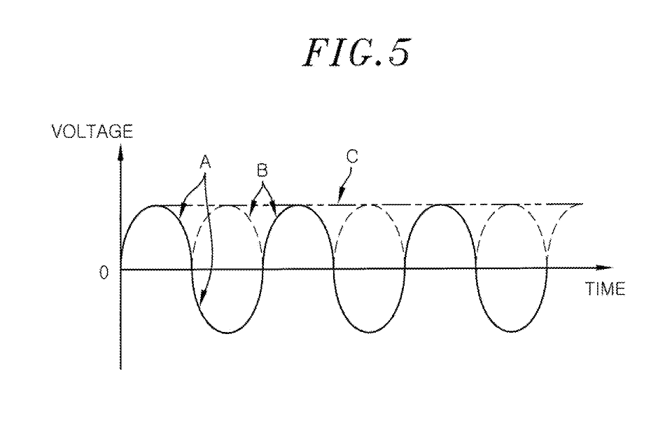

In LED power supply device 210, the rectifier 212 is configured to include a plurality of diodes. Such a rectifier 212 rectifies an externally input AC voltage (for example, AC 110V˜220V) into a DC voltage V₀₁. More specifically, the input AC voltage having a waveform A is rectified through the rectifier 212 and converted into the DC voltage having a waveform B, as shown in FIG. 5.

Also, the smooth unit 214, which may include a lossless low pass filter configured with an inductor, a capacitor, and the like, eliminates or reduces ripple voltage components included in the DC voltage V₀₁ which is rectified through the rectifier 212, thereby enabling its output voltage V₀₂ to maintain a fixed (or constant) DC level. In other words, the rectified DC voltage V₀₁ having the waveform B is smoothed by the smooth unit 214 to be a smoothed DC voltage having a waveform C, as shown in FIG. 5.

The power factor compensator 216 compensates for a power factor according to the DC voltage V_{O2} from the smooth unit 214 and an electric current flowing through loads in downstream. To this end, the power factor compensator 216 performs a function of phase-synchronizing the DC voltage V₀₂ with a total load electric current I_{LOAD}.

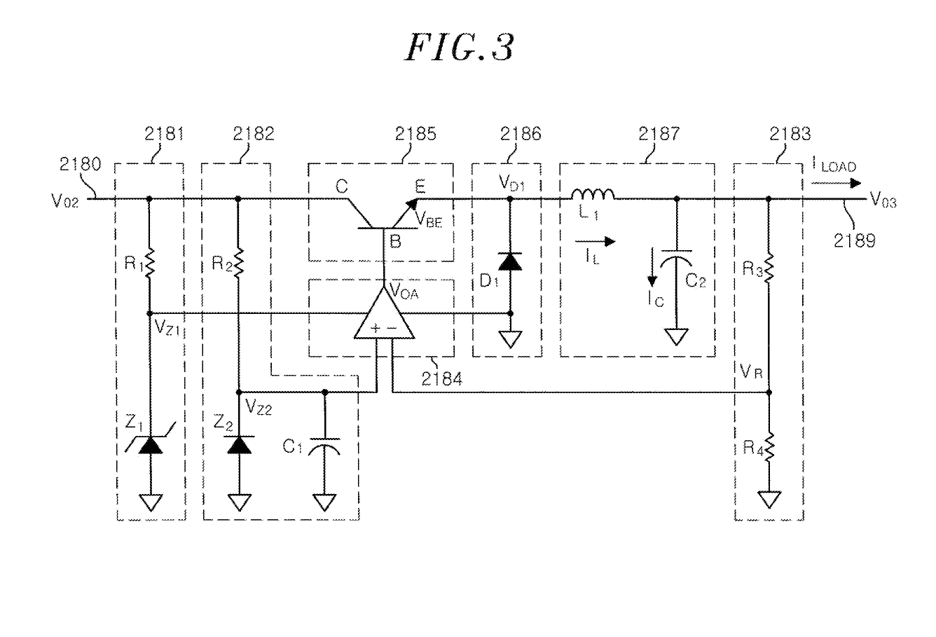

The stepdown DC-DC converter 218 steps-down the DC voltage V₀₂, which is smoothed by the smooth unit 214 and power-factor-compensated by the power factor compensator 216, to a voltage required by the LED controller 220. The stepped-down voltage, i.e., a third DC voltage V₀₃, is applied to the LED controller 220. Such a stepdown DC-DC converter 218 may be configured, for example, as shown in FIG. 3.

FIG. 3 is a detailed circuitry diagram of the stepdown DC-DC converter 218 shown in FIG. 2. The stepdown DC-DC converter 218 includes a driving voltage supplier 2181, a reference voltage supplier 2182, a feedback unit 2183, a first operational amplifier 2184, a switch unit 2185, a protective circuit 2186, and a charge and discharge circuit 2187.

The voltage supplier 2181 provides a driving DC voltage necessary to drive the first operational amplifier 2184. The voltage supplier 2181 includes a first resistor R₁ with one end connected to the output V₀₂ of the smooth unit 214, and a first zener diode Z₁ having a cathode electrode connected to the other end of the first resistor R₁ and an anode electrode connected to a ground source. The first zener diode Z₁ generates a first zener diode voltage V_{Z1} at the cathode electrode thereof. The first zener diode voltage V_{Z1} is then applied to the first operational amplifier 2184, which is used as a driving DC voltage for driving the first operational amplifier 2184.

The reference voltage supplier 2182 applies a first reference voltage to a non-inverting terminal (+) of the first operational amplifier 2184. The reference voltage supplier 2182 includes: a second resistor R₂ having one end connected to the output V_{O2} of the smooth unit 214; a second zener diode Z₂ having an anode electrode connected to the ground source and a cathode electrode connected to the other end of the second resistor R₂; and a first capacitor C₁ having one end connected to a node between the cathode electrode of the second zener diode Z₂ and the non-inverting terminal (+) of the first operational amplifier 2184 and the other end connected to the ground source. The second zener diode Z₂ generates a second zener diode voltage V_{Z2} at its cathode electrode (−), which is then supplied to the non-inverting terminal (+) of the first operational amplifier 2184 as a first reference voltage. In this case, the capacitor C₁ is used for stabilizing an operation range of the first operational amplifier 2184. More specifically, when the first zener diode voltage V_{Z1} is higher than the second zener diode voltage V_{Z2} (i.e., V_{Z2}<V_{Z1}), the capacitor C₁ maintains a rising time of the second zener diode voltage V_{Z2} to become lengthier than that of the first zener diode voltage V_{Z1} at the initial operation of the first operational amplifier 2184 so that the first operational amplifier 2184 does not damage.

The feedback unit 2183 applies a part of the stepped-down voltage V_{O3} on the output from the stepdown DC converter 218 to an inverting terminal (−) of the first operational amplifier 2184. The feedback unit 2183 includes: a third resistor R₃ having one end connected to the output V_{O3} of the stepdown DC-DC converter 218, and a fourth resistor R₄ having one end connected to the other end of the third resistor R₃. The other end of the fourth resistor R₄ is connected to the ground source. A connection node between the third and fourth resistors R₃ and R₄ serially connected each other is connected to the inverting terminal (−) of the first operational amplifier 2184. The third and fourth resistors R₃ and R₄ divide the stepped-down voltage V_{O3} of the stepdown DC-DC converter 218. The divided voltage V_{R} (=V_{O3}(R₄/(R₃+R₄)) generated by the third and fourth resistors R₃ and R₄ is applied to the inverting terminal (−) of the first operational amplifier 2184 as a feedback voltage V_{R}.

The output voltage V_{O3} from the stepdown DC-DC converter 218 is determined from the following equation 1. Also, the feedback voltage V_{R} derived from the final output voltage V_{O3} of the stepdown DC-DC converter 218 can be properly set up by adjusting values of the third and fourth resistors R₃ and R₄.

$${V}_{03} \approx ( 1 + \frac{{R}_{3}}{{R}_{4}} ) {V}_{Z 2} \qquad [ Equation 1 ]$$

The first operational amplifier 2184 includes the non-inverting terminal (+) receiving the first reference voltage V_{Z2} and the inverting terminal (−) receiving the second reference voltage V_{R} of the feedback voltage. Also, the first operational amplifier 2184 is driven by the driving DC voltage V_{Z1} which is applied from the driving voltage supplier 2181. Such a first operational amplifier 2184 controls a switching operation of the switch unit 2185 on the basis of the first reference voltage V_{Z2} and the feedback voltage V_{R}. To this end, the first operational amplifier 2184 operationally amplifies the first reference voltage V_{Z2} and the feedback voltage V_{R}. The output voltage V_{OA} of the operational amplifier 2184 is applied to the base electrode B of a transistor which is included in the switch unit 2185. The transistor of the switch unit 2185 may be either an NPN bipolar junction transistor or an NPN darlington bipolar junction transistor.

Also, the switch unit 2185 selectively transfers the smoothed voltage (i.e., the second DC voltage) V_{O2} on a DC voltage input line 2180 toward a voltage output line 2189 according to the output voltage of the first operational amplifier 2184. When the smoothed voltage V_{O2} is transferred toward the voltage output line 2189, the transistor within switch unit 2185 amplifies β times a base electric current I_{B} at its base electrode B and generates an emitter electric current I_{E} (i.e., the β times-amplified current) at its emitter terminal E. Therefore, the output voltage V_{O3} (i.e., the third DC voltage) of the stepdown DC-DC converter 218 generated by the switch unit 2185 is determined from the following equation 2.

V_{O3}≈V_{D1}=V_{OA}−V_{BE} [Equation 2]

In the equation 2, V_{OA} is an output voltage of the first operational amplifier 2184.

The protective circuit 2186 includes a diode D₁ such as a schottky diode or a fast recovery switching diode. Such a diode D₁ protects the switch unit 2185 from a back electro motive force which is caused the switching operation of the switch unit 2185. To this end, the diode D₁ allows the switched voltage V_{D1} at its cathode electrode to not be lowered below a ground level.

The charging/discharging circuit 2187 includes: an inductor L₁ being connected to an output terminal of the switch unit 2185 and receiving the switched voltage Vᵢₙ; and a second capacitor C₂ having one end connected to the ground source and the other end connected to the inductor L₁. The charging and discharging circuit 2187 prevents the steep variation of an electric current applied to a load, i.e., LED module 230.

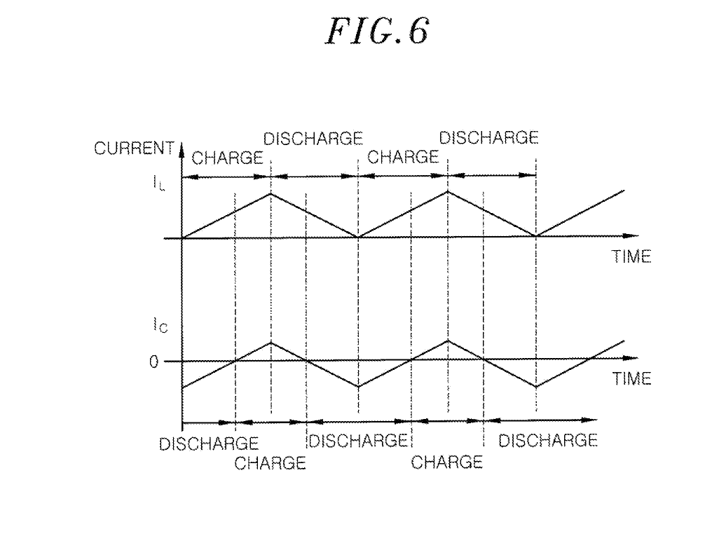

The transistor of the switch unit 2185 is turned-on to apply the voltage V_{D1} to the inductor L₁ during a charging phase shown in FIG. 6. Then, an electric current I_{L} flowing through the inductor L₁ gradually increases and an electric current I_{c} flowing through the second capacitor C₂ also gradually increases, by means of the voltage V_{D1} applied to the inductor L₁. On the contrary, during a discharging phase, the electric current I_{C} is applied to the load (for example, the LED controller 220) and the feedback unit 2183 which are linked to the output terminal of the stepdown DC-DC converter 218. The feedback unit 2183 supplies the feedback voltage to the inverting terminal (−) of the operational amplifier 2184.

More specifically, since the voltage V_{D1} is zero (‘0’) when the transistor within the switch unit 2185 is turned-off, the energy charged into the inductor L₁ in the charging phase is slowly discharged through the diode D₁ during the discharging phase. At the same time, the second capacitor C₂ included in the charging and discharging circuit 2187 supplies the load with voltage which is charged in the charging phase, thereby preventing the steep variation of an electric current flowing the load. In other words, when the output electric current I_{LOAD} of the feedback unit 2183 increases, the feedback voltage V_{R} is larger than the reference voltage (i.e., the second zener diode voltage) V_{Z2} so that the switch unit 2185 is turned-off. Therefore, the energy which is previously charged in the second capacitor C₂ by the electric current I_{L} being passed through the inductor L₁, is applied to the load connected to the voltage output line V_{O3} of the stepdown DC-DC converter 218. On the contrary, the switch unit 2185 is turned-on when the feedback voltage V_{R} is smaller than the first reference voltage (i.e., the second zener diode voltage) V_{Z2} (i.e., at the time of V_{R}<V_{Z2}), thereby enabling the electric current I_{L} to flow through the inductor L₁. As such, the energy is charged in the inductor L₁ and the capacitor C₂ and then applied to the load connected to the output of the stepdown DC-DC converter 218 in the discharging phase. Therefore, a constant load voltage V_{O3} can be applied to the LED controller 220.

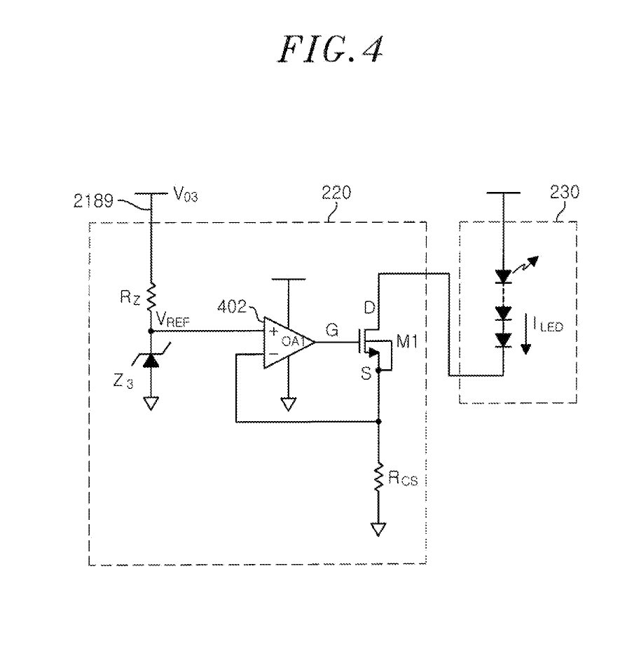

Returning to FIG. 2, the LED controller 220 uses the output voltage V_{O3} of the stepdown DC-DC converter 218 as an input voltage. Also, the LED controller 220 maintains a constant electric current to flow through LED lamps, which are included in the LED module 230. Such an LED controller 220 may be configured as a circuit illustrated in FIG. 4. The output voltage V_{O3} of the stepdown DC-DC converter 218 is input to a fifth resistor R_{Z}. A third zener diode Z₃ is connected to the fifth resistor R_{Z}. The fifth resistor R_{Z} and the third zener diode Z₃ generate a second reference voltage V_{REF}. The second reference voltage V_{REF} is applied to a non-inverting terminal (+) of a second operational amplifier 402. An inverting terminal (−) of the second operational amplifier 402 is connected to one end of a sixth resistor R_{CS}. The other end of the sixth resistor R_{CS} is connected to the ground source. Also, the inverting terminal (−) of the second operational amplifier 402 is connected to a source electrode S of a power transistor M1 such as an N-type MOSFET (Metal Oxide Silicon Field Effect Transistor). An output terminal of the second operational amplifier 402 is connected to a gate electrode G of the power transistor M1. A drain electrode D of the power transistor M1 is connected to a cathode electrode of the last LED included a serial circuit of plural LEDs within the LED module 230. An input terminal of the LED module 230, i.e., an anode electrode of the first LED within the LED module 230, receives an arbitrary DC voltage necessary for providing an output required by the LED module 230. The output terminal of the LED controller 220 (i.e., the drain electrode of the power transistor M1), connected to the cathode electrode of the last LED within the LED module 230 is used to control an electric current I_{LED} flowing through the LEDs within the LED module 230 so that the LEDs emit light. Alternatively, the LEDs included in the LED module 230 may be connected with one another to form two or more serial and/or parallel circuits. Moreover, the second operational amplifier 402 may be driven by the driving DC voltage V_{Z1} which is generated by the voltage supplier shown in FIG. 3.

If the electric current I_{LED} flowing through the LEDs increases, the voltage at the inverting terminal (−) of the second operational amplifier 402 becomes larger than the second reference voltage V_{REF}. As such, the voltage difference between the gate and source electrodes of the power transistor M1 is lowered to decrease the electric current I_{LED} flowing through the LEDs. On the contrary, if the electric current I_{LED} flowing through the LEDs decreases, the voltage at the inverting terminal (−) of the second operational amplifier 402 becomes smaller than the second reference voltage V_{REF}. At this time, the voltage difference between the gate and source electrodes of the power transistor M1 is enlarged, thereby increasing the electric current I_{LED} flowing through the LEDs. In this manner, the electric current I_{LED} flowing through the LED module 230 is constantly maintained by the second reference voltage V_{REF} and a value of the sixth resistor R_{CS}. Such an electric current I_{LED} flowing through the LED module 230 is determined from the following equation 3.

I_{LED}=V_{REF}/R_{CS} [Equation 3]

As described above, the present invention provides an LED power supply device, which is suitable to supply a DC voltage required by the LED controller, without employing a transformer. Therefore, the present invention can effectively solve the volume problem caused by the physical structure of the transformer, by providing a driving circuit including the LED controller.

While the invention has been shown and described with respect to the preferred embodiments, it will be understood by those skilled in the art that various changes and modifications may be made without departing from the scope of the invention as defined in the following claims.

What is claimed is:

1. A stepdown DC-DC converter for supplying a power supply voltage necessary to control the operation of an LED (Light Emitting Diode), comprising:
a reference voltage supplier for providing a reference voltage;
a feedback unit for feeding back the power supply voltage on an output line of the stepdown DC-DC converter;
an operational amplifier for performing an operational amplification on the reference voltage and the fed-back power supply voltage;
a switch unit for switching on/off a DC voltage on an input line of the stepdown DC-DC converter toward the output line; and
a charging and discharging circuit for selectively performing a charging operation of the switched voltage from the switch unit and a discharging operation of its charged voltage according to the switching operation of the switch unit to provide the power supply voltage to the output line.

2. The stepdown DC-DC converter of claim 1, further comprising a voltage supplier for providing a driving DC voltage necessary to drive the operational amplifier.

3. The stepdown DC-DC converter of claim 2, wherein the voltage supplier includes:
a first resistor having one end connected to the input line; and
a first zener diode, which includes a cathode electrode connected to a ground source and an anode electrode connected to the other end of the resister, for providing the driving DC voltage necessary to drive the operational amplifier using a zener diode voltage generated at its cathode electrode.

4. The stepdown DC-DC converter of claim 1, wherein the reference voltage supplier includes:
a second resistor having one end connected to the input line;
a second zener diode having a cathode electrode connected to a ground source and an anode electrode connected to the other end of the second resistor; and
a first capacitor having one end connected to a node between the cathode electrode of the second zener diode and a non-inverting terminal of the operational amplifier and the other end connected to the ground source.

5. The stepdown DC-DC converter of claim 1, wherein the feedback unit includes:
third and fourth resistors serially connected to the output line, the fourth resistor having one end connected to a ground source; and
a connection node, between the third and fourth resisters, connected to apply the fed-back voltage to an inverting terminal of the operational amplifier.

6. The stepdown DC-DC converter of claim 1, wherein the switch unit includes any one of an NPN bipolar junction transistor and an NPN darlington bipolar junction transistor.

7. The stepdown DC-DC converter of claim 1, further comprising a protective circuit for protecting the switch unit.

8. The stepdown DC-DC converter of claim 7, wherein the protective circuit includes any one of a schottky diode and a fast recovery switching diode.

9. An LED (Light Emitting Diode) power supply device for supplying a power supply voltage to an LED controller controlling the operation of an LED lamp, comprising:
a rectifier for rectifying an input AC voltage into a DC voltage;
a smooth unit for eliminating a ripple voltage included in the rectified DC voltage to produce a smoothed voltage;
a power factor compensator for performing power factor compensation by phase-synchronizing the smoothed voltage with a total load electric-current; and
a stepdown DC-DC converter for stepping down the power-factor-compensated DC voltage into the power supply voltage required by the LED controller.

10. The LED power supply device of claim 9, wherein the smooth unit includes a lossless low pass filter.

11. The LED power supply device of claim 9, wherein the stepdown DC-DC converter includes:
an input line for receiving the power-factor-compensated DC voltage from the power factor compensator;
a reference voltage supplier for providing a reference voltage;
a feedback unit for feeding back the power supply voltage on an output line of the stepdown DC-DC converter;
an operational amplifier for performing an operational amplification on the reference voltage and the fed-back power supply voltage;
a switch unit for switching on/off the power-factor-compensated DC voltage on the input line toward the output line; and
a charging and discharging circuit for selectively performing a charging operation of the switched voltage from the switch unit and a discharging operation of its charged voltage according to the switching operation of the switch unit to provide the power supply voltage to the output line.

12. The LED power supply device of claim 11, further comprising a voltage supplier for providing a driving DC voltage necessary to drive the operational amplifier.

13. The LED power supply device of claim 12, wherein the voltage supplier includes:
a first resistor having one end connected to the input line; and
a first zener diode, which includes a cathode electrode connected to a ground source and an anode electrode connected to the other end of the resister, for providing the driving DC voltage necessary to drive the operational amplifier using a zener diode voltage generated at its cathode electrode.

14. The LED power supply device of claim 11, wherein the reference voltage supplier includes:
a second resistor having one end connected to the input line;
a second zener diode having a cathode electrode connected to a ground source and an anode electrode connected to the other end of the second resistor; and
a first capacitor having one end connected to a node between the cathode electrode of the second zener diode and a non-inverting terminal of the operational amplifier and the other end connected to the ground source.

15. The LED power supply device of claim 11, wherein the feedback unit includes:
third and fourth resistors serially connected to the output line, the fourth resistor having one end connected to a ground source; and
a connection node, between the third and fourth resisters, connected to apply the fed-back voltage to an inverting terminal of the operational amplifier.

16. The LED power supply device of claim 11, wherein the switch unit includes any one of an NPN bipolar junction transistor and an NPN darlington bipolar junction transistor.

17. The LED power supply device of claim 11, further comprising a protective circuit for protecting the switch unit.

18. The LED power supply device of claim 17, wherein the protective circuit includes any one of a schottky diode and a fast recovery switching diode.

19. A method of supplying a power supply voltage to an LED controller controlling the operation of an LED lamp, comprising:
rectifying an input AC voltage into a DC voltage before eliminating a ripple voltage included in the rectified DC voltage to produce a smoothed voltage;
performing power factor compensation for the smoothed voltage in synchronization with the phase of a total load electric-current to produce a power-factor-compensated DC voltage; and
stepping-down the power-factor-compensated DC voltage into the power supply voltage required by the LED controller and applying the stepped-down voltage to the LED controller.

20. The method of claim 19, wherein said applying the stepped-down voltage to the LED controller includes:
feeding back the stepped-down voltage;
operationally amplifying the fed-back voltage a reference voltage;
switching on/off the power-factor-compensated voltage according to the operationally amplified voltage; and
selectively performing a charging operation of the switched voltage and a discharging operation of a charged voltage according to the voltage switching operation so that the stepped-down voltage is generated.
